(19) United States
(12) Patent Application Publication
(10) Pub. No.: US 2023/0090299 A1
(43) Pub. Date: Mar. 23, 2023

(54) INTRINSICALLY SAFE, REUSABLE, POWER MODULE FOR FIELD DEVICES

(71) Applicant: Rosemount Inc., Shakopee, MN (US)

(72) Inventors: Jared NEUHARTH, Prior Lake, MN (US); Cory ROBINSON, Mayer, MN (US); James JOHNSON, Savage, MN (US); Zachary MARSO, St. Louis Park, MN (US); Hun CHHUOY, Savage, MN (US); Greg E. GINDELE, Maple Lake, MN (US); Matthew POKORNY, St. Paul, MN (US)

(21) Appl. No.: 17/483,091

(22) Filed: Sep. 23, 2021

(51) Int. Cl. H01M 50/247; H01M 50/271; H01M 50/284; H01M 50/569

(52) U.S. Cl. CPC H01M 50/247; H01M 50/271; H01M 50/284; H01M 50/569

(57) ABSTRACT

A reusable power module for a field device is provided. The reusable power module includes a main body defining a chamber configured to house a battery. A cover is operably coupled to the main body and has a first configuration relative to the main body wherein the main body is open and allows access to the battery. The cover also has a second configuration wherein access to the battery is closed. When the cover is in the second configuration, the reusable power module complies with an intrinsic safety specification.

### BACKGROUND

The present invention relates generally to industrial process control and monitoring systems. More particularly, the present invention relates to wireless process field devices for use in such systems.

In industrial settings, process control systems are used to monitor and control inventories and operation of industrial and chemical processes, and the like. Typically, the system that performs these functions uses field devices distributed at key locations in the industrial process coupled to control circuitry in a control room by a process control loop. The term “field device” refers to any device that performs a function in a distributed control or process monitoring system, including all devices used in the measurement, control, and monitoring of industrial processes. Usually, such field devices have a field-hardened enclosure so that they can be installed outdoors in relatively rugged environments and be able to withstand climatological extremes of temperature, humidity, vibration, and mechanical shock.

Typically, each field device also includes communication circuitry that is used for communicating with a process controller, or other field devices, or other circuitry, over the process control loop. In some installations, the process control loop is also used to deliver a regulated current and/or voltage to the field device for powering the field device. The process control loop also carries data, either in an analog or digital format.

In some installations, wireless technologies are now used to communicate with field devices. Wireless operation simplifies field device wiring and setup. Wireless installations are currently used in which the field device includes a local power source. However, because of power limitations, the functionality of such wireless field devices may be limited.

Wireless field devices may employ an intrinsically safe local power source that maybe replaceable when the energy of the power source becomes depleted or below a selected threshold. Intrinsic safety is a term that refers to the ability of the field device to operate safely in potentially volatile environments. For example, the environment in which field devices operate can sometimes be so volatile that an errant spark or sufficiently high surface temperature of an electrical component could cause the environment to ignite and generate an explosion. To ensure that such situations do not occur, intrinsic safety specifications have been developed. Compliance with an intrinsic safety requirement helps ensure that even under fault conditions, the circuitry or device itself cannot ignite a volatile environment. One specification for an intrinsic safety requirement is set forth in: APPROVAL STANDARD INTRINISICALLY SAFE APPARATUS AND ASSOCIATED APPARATUS FOR USE IN CLASS I, II AND III, DIVISION 1 HAZARDOUS (CLASSIFIED) LOCATIONS, CLASS 3610, promulgated by Factory Mutual Research October 1988. Adaptations to comply with additional industrial standards such as Canadian Standards Association (CSA) and the European Cenelec standards are also contemplated.

### SUMMARY

A reusable power module for a field device is provided. The reusable power module includes a main body defining a chamber configured to house a battery. A cover is operably coupled to the main body and has a first configuration relative to the main body wherein the main body is open and allows access to the battery. The cover also has a second configuration wherein access to the battery is closed. When the cover is in the second configuration, the reusable power module complies with an intrinsic safety specification.

### BRIEF DESCRIPTION OF THE DRAWINGS

FIG. 1 is an exploded view diagram of an upper portion of a wireless measurement transmitter with which embodiments described herein are particularly applicable.

FIG. 2 is an exploded view diagram of a lower portion of a wireless measurement transmitter with which embodiments described herein are particularly applicable.

FIG. 3 is a cross-sectional view of a known replaceable power module in accordance with the prior art.

FIG. 4 is a diagrammatic view of a wireless measurement transmitter having a replaceable module with which embodiments of the present invention are particularly applicable.

FIGS. 5 and 6 are perspective views of a reusable single D-cell battery intrinsically safe power module in accordance with an embodiment of the present invention.

FIG. 7 is a diagrammatic view of internal features of a reusable single D-cell power module in accordance with an embodiment of the precent invention.

FIGS. 8A and 8B are diagrammatic views illustrating the utilization of a pair of springs to provide polarity protection in accordance with an embodiment of the present invention.

FIG. 9 is a perspective view of a reusable, single D-cell reusable power module in accordance with another embodiment of the present invention.

FIG. 10 is a perspective view of a reusable, single D-cell reusable power module in accordance with another embodiment of the present invention.

FIG. 11 is a flow diagram of a method of using a non-intrinsically safe primary power cell in a reusable power module to provide power to a field device located in a hazardous location in accordance with an embodiment of the present invention.

### DETAILED DESCRIPTION OF ILLUSTRATIVE EMBODIMENTS

Currently, power modules for wireless field devices are relatively expensive, and may be used only once. Thus, when the power module needs to be replaced, the entire power module must be removed and discarded in accordance with local recycling regulations. In addition to the primary battery (which is generally a lithium-based primary battery) the plastic surrounding the battery as well as any circuitry of the power module is also discarded. Various embodiments described below, generally employ a new reusable power module that can be opened to remove and replace a depleted primary lithium battery cell. Moreover, embodiments generally make use of an off-the-shelf primary lithium battery cell rather than a custom cell. These types of lithium cells are common and are available from several distributors. The ability for an end user to replace the battery cell and reuse the power module provides a significant advantage over current offerings. A lithium primary cell, on its own, is not an intrinsically safe device. Embodiments provided herein provide a power module that can receive the commercial off-the-shelf lithium primary cell and provide an enclosure that may be opened to receive the cell and then closed to provide an intrinsically-safe power module that may be then brought to the location of the field device and exchanged with a depleted power module even in a volatile environment.

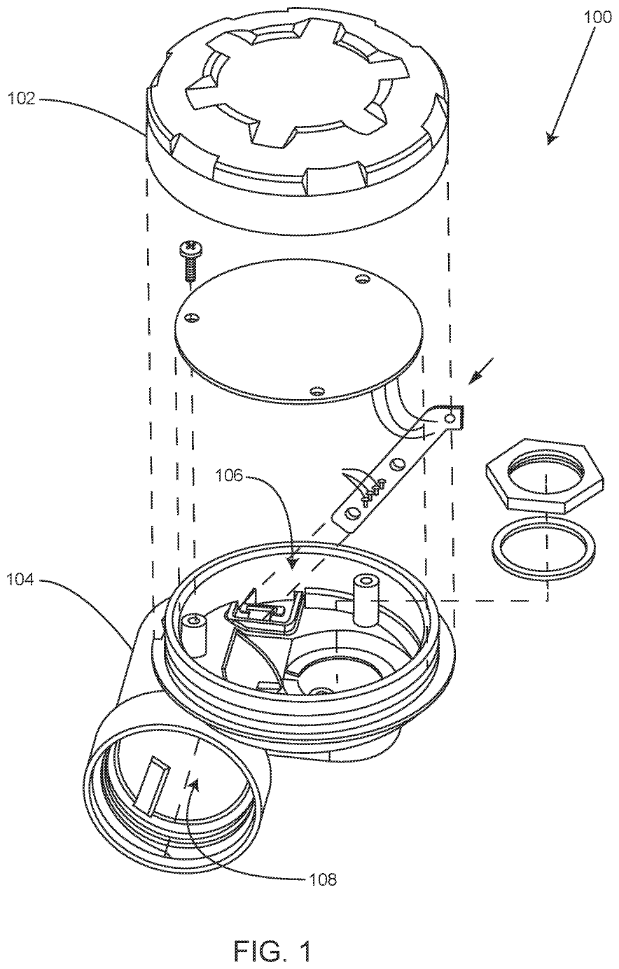

FIG. 1 is an exploded view of an upper portion of a wireless measurement transmitter with which embodiments described herein are particularly applicable. Wireless measurement transmitter 100 includes a housing assembly formed by upper and lower housing components 102, 104, respectively. The housing assembly generally has a main housing body that includes cavity 106. Lower housing 104 includes a second chamber 108 that is sized and shaped to receive replaceable power module 110.

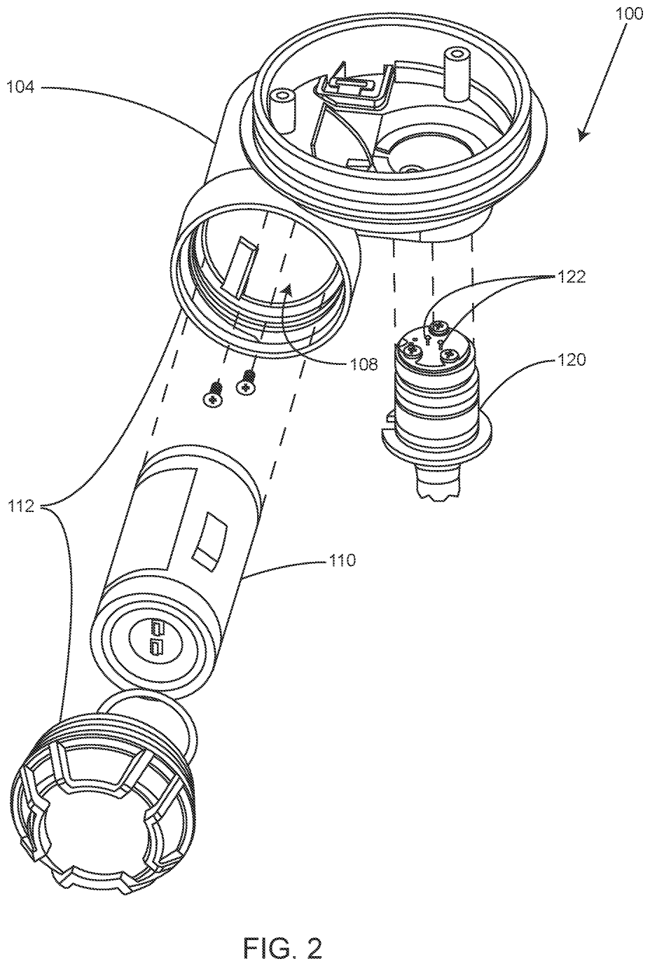

FIG. 2 is an exploded view diagram of a lower portion of a wireless measurement transmitter with which embodiments described herein are particularly applicable. As shown in FIG. 2, replaceable power module 110 is enclosed within chamber 104 by cooperation of housing 104 and end cap 112 by threadably engaging the housing and end cap together. The use of two covers (102, and 112), as well as two cavities (106 and 108), permits service operations (for example primary battery replacement, adjustment of settings) by removing second cover 112 without exposing electronic components disposed in first cavity 106 to contamination from the surrounding industrial environment, and without exposing first cavity 106 to the atmosphere of the surrounding industrial environment. As shown in FIG. 2, wireless measurement transmitter 100 may include a measurement sensor 120 that is coupleable to electronics within cavity 106 by virtue of electrical contacts 122. Examples of measurement sensors include temperature sensors, pressure sensors, gas sensors, humidity sensors, et cetera.

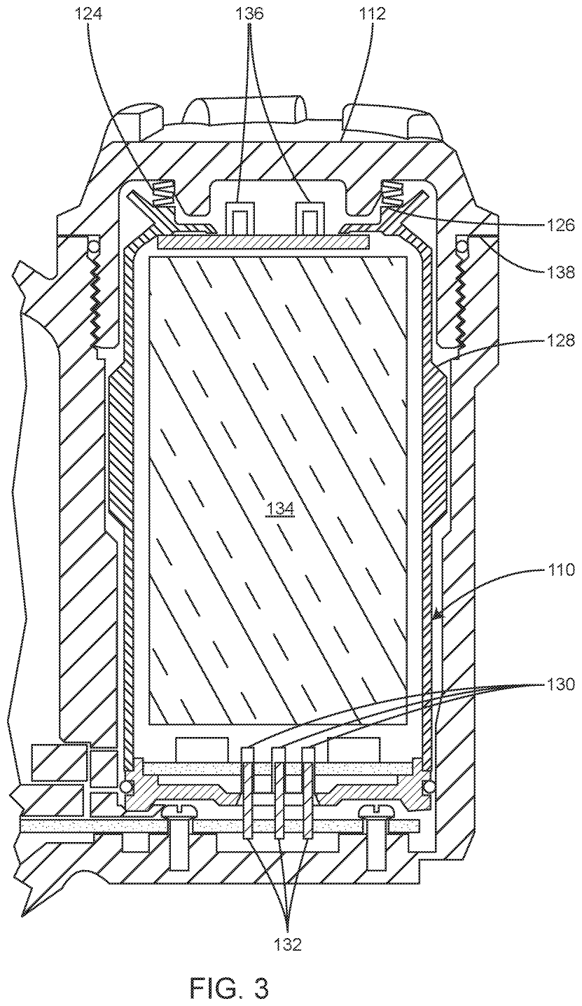

FIG. 3 is a cross-sectional view of a portion of a wireless measurement transmitter illustrating a replaceable power module located within chamber 108, in accordance with the prior art. Replaceable module 110 is installed in cavity 108 which is closed by cover 112. When this occurs, spring 124 is compressed between cover 112 and the thrust surface 126 of the outer shell 128 of replaceable module 110. As shown in FIG. 3, the replaceable module 110 generally includes contacts 130 that engage corresponding contacts 132 in cavity 108. Replaceable module 110 includes the primary battery 134 as well as a service communication connector 136 that protrudes beyond rim 138 of cavity 108 when cover 112 is removed. Accordingly, the wireless measurement transmitter is entirely powered by energy from primary battery 134.

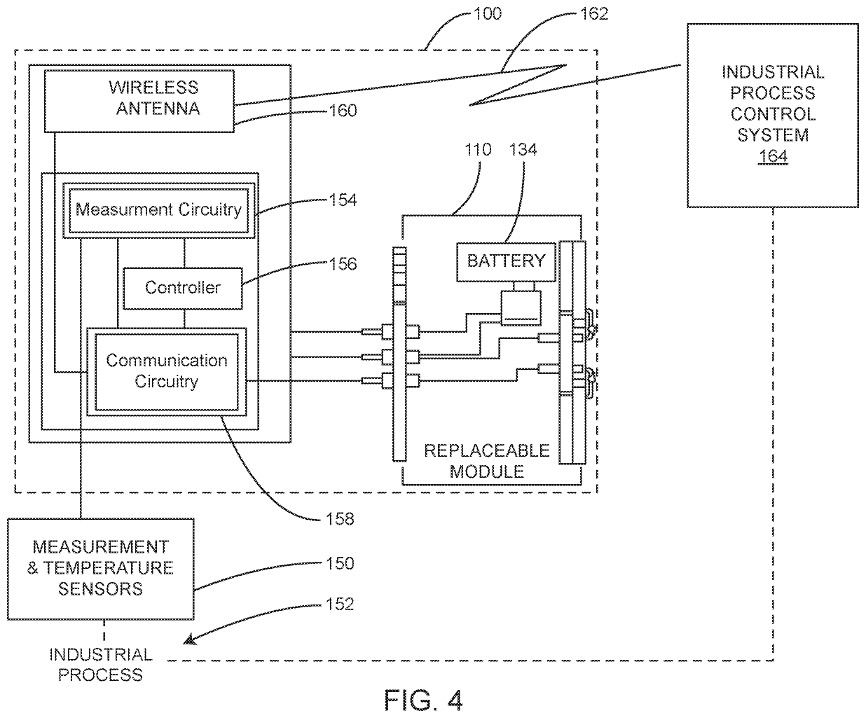

FIG. 4 is a diagrammatic view of a wireless measurement transmitter connected to a measurement sensor with which embodiments of the present invention are particularly applicable. As shown in FIG. 4, transmitter 100 is coupled to measurement and temperature sensors 150, which are, in turn, coupled to an industrial process 152. The measurement and temperature sensors 150 are coupled to measurement circuitry 154 of wireless transmitter 100. Measurement circuitry 154 receives an electrical output from the measurement sensor 130 that represents a process variable that is sensed from an industrial process 152. In one example, measurement sensor(s) 150 senses temperature and the measurement circuitry 154 may determine a process state as a function of the temperature. Measurement circuitry 154 provides an output representative of the process state to controller 156.

Controller 156 may be any suitable circuitry or combination of circuitry that executes programmatic steps to generate a process variable based upon signals received from measurement circuitry 154. In one example, controller 156 is a microprocessor. Controller 156 is also coupled to communication circuitry 158 which can receive the process variable output information from controller 156 and provide wireless industry standard process communication signals based thereon. Preferably, communication circuitry 158 allows bidirectional wireless communication utilizing wireless antenna 160. As shown diagrammatically at reference numeral 162, this bidirectional wireless communication generally communicates with the industrial process control system 164. An example of a suitable wireless process communication protocol is set forth in IEC 62591. However, other examples instead of or in addition to IEC 62591 are also contemplated.

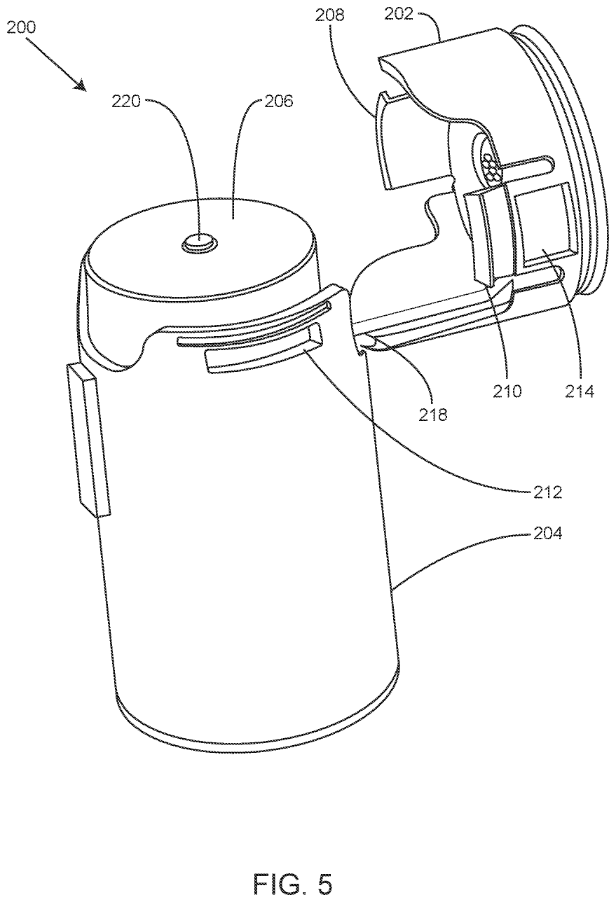

FIG. 5 is a perspective view of an intrinsically safe, reusable, single D-cell power module for field devices in accordance with an embodiment of the present invention. Power module 200 is shown in FIG. 5 in an open configuration where top 202 is pivoted away from main body 204 to allow a commercially-available off-the-shelf primary D-cell battery 206 to be accessed. Preferably, the D-cell battery is a primary battery employing lithium-ion chemistry. The access provided by power module 200 facilitates removing a depleted D-cell cell and placing a new D-cell therein. Once the new cell is placed in main body 204, top 202 is pivoted back into position, and the enclosure is closed. This closed configuration is shown in FIG. 6.

In the closed configuration, module 200 preferably has virtually the same form factor as prior art replaceable power modules. Thus, such a reusable power module could be placed into operation with legacy systems that were designed for prior art modules. In one embodiment, the power module enclosure includes four injection molded parts of which two are external and two are internal. The external parts (shown in FIGS. 5 and 6) create the enclosure which the end user can open and close by releasing or engaging snaps between the two positions 202, 204. These snaps are illustrated at reference numerals 208 and 210 in FIG. 5. Snaps 208, 210 engage corresponding slots 212 in main body 204. Additionally, recesses 214 allow snaps to be disengaged from slots 212 by the user's fingers. The separable enclosure allows the end user to easily remove and replace the battery cell. As set forth above, the form factor of the reusable power module is preferably matched to current commercially available single-use power modules and employs the same external electrical connections to allow it to be used in legacy field devices.

The internal polymer components may include shrouds (not shown) that protect the electronic boards (printed circuit boards) from user contact as well as from damage during replacement of the battery cell. When the battery is located within the enclosure, and the enclosure is closed, the entire assembly is intrinsically safe and can be installed into field devices in hazardous locations. However, the lithium cell must be removed from and/or installed in the enclosure in a non-hazardous area, since the raw primary D-cell is not I.S. rated outside of the enclosure. To be I.S. rated, the device must meet the requirements set forth above or other applicable international standards deemed fit by approving agencies. This includes mechanical and electrical design requirements such as wire/conductor insulation thickness, enclosure material properties, and mechanical testing.

To create a robust internal connection to the battery cell, a pair of conical springs is preferably used on the negative terminal of the cell. The purpose of this pair of conical springs is also mechanical in nature in that they will hold the positive terminal end of the cell against one of the internal shrouds thereby securing it in both a drop event and a strong vibrational response. Preferably, there is also a set of redundant spring-loaded pins that make contact with the positive battery cell terminal completing the circuit to provide power to the field device. There are three wires (power, common, and HART COMM), connecting the two printed circuit boards within the enclosure. The field communicator connection (COMM clips 216 illustrated in FIG. 6) are preferably located on the end of the power module. The field communicator connection allows easy wired access to the field device by a handheld field maintenance device such that a technician can interact with the field device during maintenance and/or commissioning.

In the embodiments shown in FIGS. 5 and 6, each of the top housing and bottom housing preferably include their own respective printed circuit boards. Each of these printed circuit boards is electrically coupled together via a connection at hinged portion 218 (shown in FIG. 5). The top housing assembly contains a printed circuit board that contains connectors to connect to a communication device, such as the handheld field maintenance device described above, and a connector to connect to the battery cathode 220. The bottom housing assembly 204 contains another printed circuit board as well as a spring for contacting the battery anode. Additionally, bottom housing assembly contains connectors for providing power and communications to a field instrument. The bottom housing printed circuit board is electrically coupled to the top housing printed circuit board through connectors passing through hinge portion 218. This connection provides power from the opposite end of the battery as well as carries communication signals when COMM clips 216 are used.

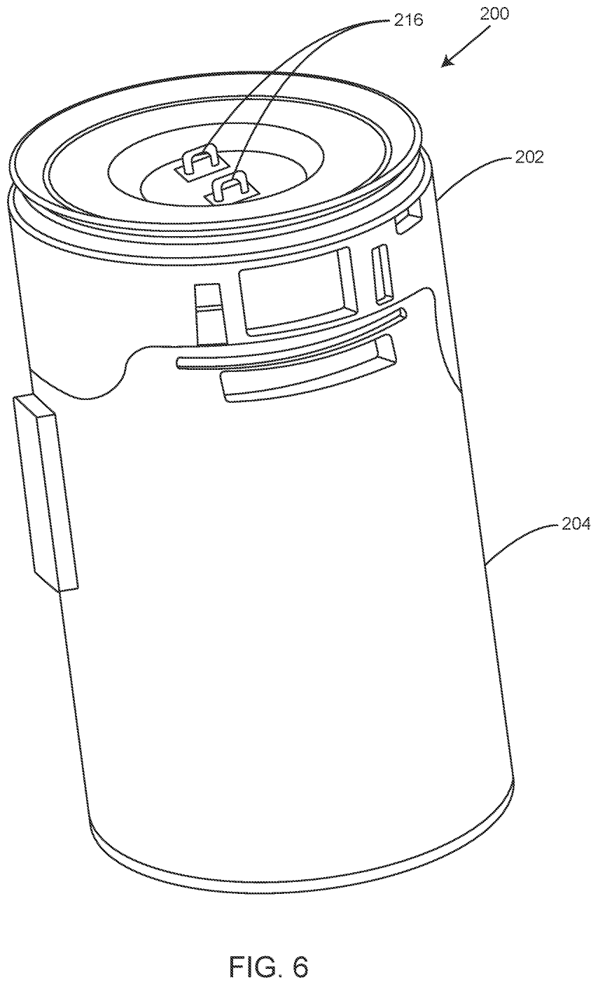

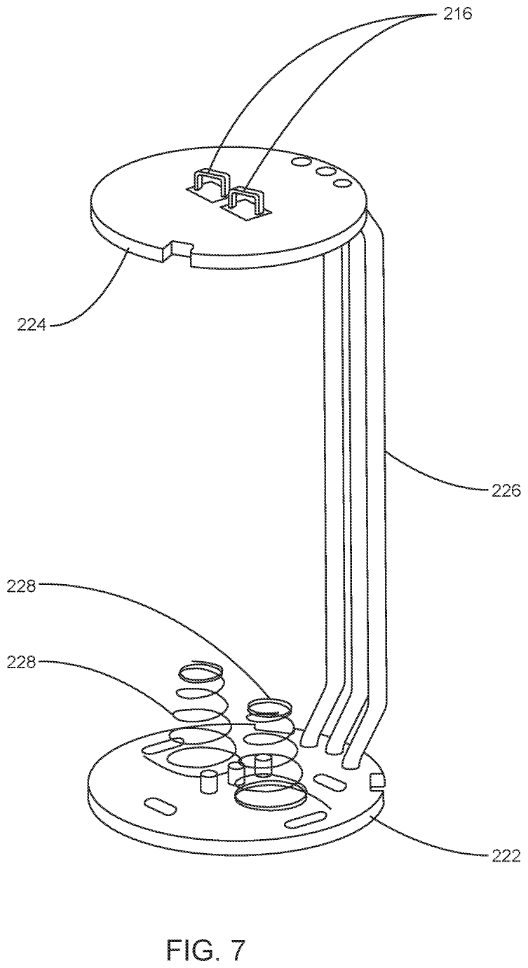

FIG. 7 is a diagrammatic view of internal features of a reusable single D-cell power module in accordance with an embodiment of the precent invention. Power module 200 includes a pair of circuit boards 222, 224 coupled together by conductors 226. One of conductors 226 connects to positive terminal 220 of D-cell battery 206 (shown in FIG. 5) when cover 202 is closed. Additional conductors 226 couple comm clips 216 to pins 132 in order to communicate with electronics of transmitter 100. Each of circuit boards 222, 224 is securely mounted within polymer of the power module. FIG. 7 also illustrates a pair of springs 228 disposed on opposite sides of the center of circuit board 222. In the illustrated example, springs 228 are conical springs. It is preferred that a pair of springs 228 be used in order to provide significant force on the negative side of the D-cell battery such that even under vibration, robust electrical contact is maintained. Additionally, the utilization of a pair of springs disposed on opposite sides of the center of circuit board 222 provides passive polarity protection. The manner in which this protection is provided is described below with respect to FIGS. 8A and 8B.

FIGS. 8A and 8B are diagrammatic views illustrating the utilization of a pair of springs to provide polarity protection in accordance with an embodiment of the present invention. FIG. 8A illustrates D-cell battery 206 inserted into the power module with incorrect polarity. In this configuration, the positive terminal 206 is inserted first, and comes to rest between springs 228. When this occurs, there is no electrical contact between springs 228 and 220 and the potential for reverse polarity operation is eliminated, without resorting to additional polarity protection circuitry. This provides a significant passive protective feature without adding additional cost beyond the cost of the additional spring. As shown in FIG. 8B, when the negative terminal 230 is inserted into the power module, it will come to rest upon both springs 228 thereby providing robust mechanical and electrical contact.

While embodiments described thus far have generally provided a top portion of an enclosure that pivots away from the bottom portion to allow access to the primary battery, other mechanical techniques may be used as well.

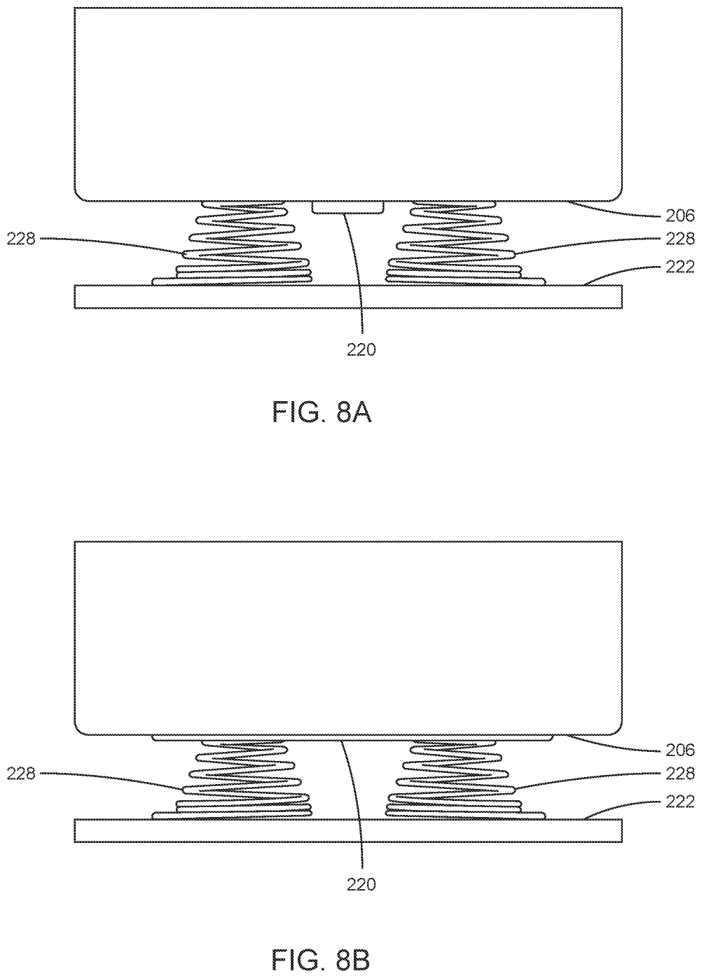

FIG. 9 is a diagrammatic view of a reusable power module that employs a “casket” style design with permanently retained electronics. The electronics could be retained by ultrasonically welded or heat staked polymer components. The power module may include a door 250 that pivots away from main body 252 to allow access to primary cell 206. As shown in FIG. 9, door 250 preferably includes a latch 254 that engages slot 256 to seal the primary cell within the power module. In this way, once door 250 is closed, the power module complies with intrinsic safety specifications thereby allowing the power module to be installed into a wireless field device in a hazardous environment. It is appreciated that additional types of connections may be utilized without departing from the spirit and scope of the invention.

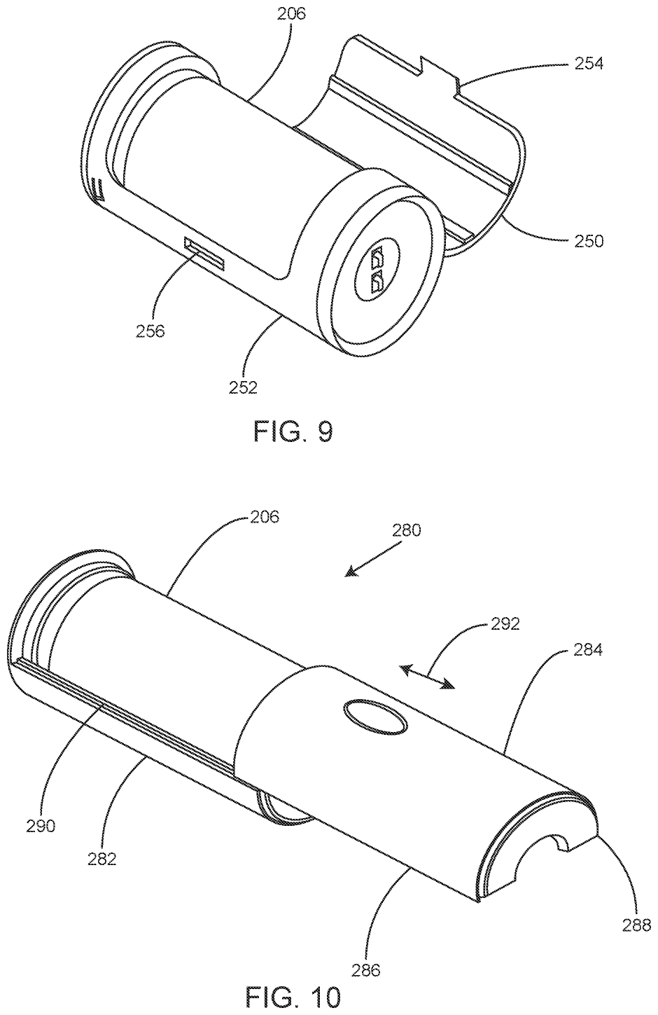

FIG. 10 is a diagrammatic view of yet another reusable power module in accordance with another embodiment of the present invention. As shown in FIG. 10, power module 280 includes a main body 282, as well as a sliding door 284 that has components of edges 286, 288, that engage corresponding slots 290 in main body 282 to allow door 284 to slide back and forth in the direction indicated in arrow 292. As shown in FIG. 8, the door has been slid open to allow access to primary cell 206.

In yet another design, a replaceable power module similar to that shown in FIGS. 5 and 6 is provided but instead of the top portion latching and pivoting away, the engagement between the top portion and the main body are via a threaded connection. In still another embodiment, the engagement may be via a quarter turn rotational engagement where features of a first part engage in features of a second part during the quarter turn which at the end of the quarter turn provide a locked configuration.

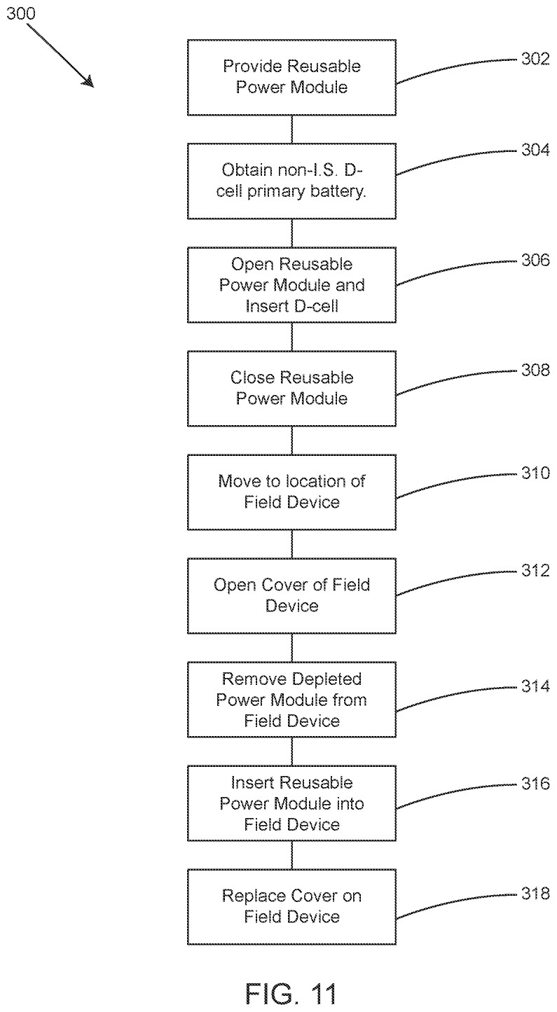

FIG. 11 is a flow diagram of a method of using a non-intrinsically safe primary power cell in a reusable power module to provide power to a field device located in a hazardous location in accordance with an embodiment of the present invention. Method 300 begins at block 302 where a reusable power module is provided. In one example, the reusable power module is that shown in FIG. 5. Next, at block 304, a non-intrinsically safe D-cell primary battery is obtained. In one example, this a commercially available D-cell battery. Preferably, the commercially available D-cell battery is a lithium battery. At block 306, the reusable power module is opened, such as shown in FIG. 5. With the reusable power module open, the D-cell battery is inserted into the power module. Next, at block 308, the cover of the reusable power module is closed, thereby rendering the reusable power module compliant with intrinsic safety requirements. As such, at block 310, the reusable power module can be taken to the location of a deployed field device (i.e., located in the “field”), which may be in a hazardous or potentially explosive environment.

At block 312, a cover of the field device is opened to expose a depleted power module. This may be a legacy power module or simply another reusable power module containing a depleted D-cell battery. At block 314, the depleted power module is removed from the field device. At block 316, the reusable power module containing the fresh or new battery is inserted into the field device. At block 318, the cover of the field device is replaced. In this way, a non-intrinsically safe D-cell battery can be placed inside a reusable power module to provide an intrinsically safe power module. The entire power module assembly may then be used to power a field device in a hazardous or potentially explosive location without removing the field device from its location (i.e., bringing it to a non-hazardous location to swap power modules).

Although the present invention has been described with reference to preferred embodiments, workers skilled in the art will recognize that changes may be made in form and detail without departing from the spirit and scope of the invention.

What is claimed is:

1. A reusable power module for a field device, the reusable power module comprising:
a main body defining a chamber configured to house a battery;
a cover operably coupled to the main body, the cover having a first configuration relative to the main body wherein the main body is open and allows access to the battery, the cover also having a second configuration wherein access to the battery is closed; and
wherein when the cover is in the second configuration, the reusable power module complies with an intrinsic safety specification.

2. The reusable power module of claim 1, wherein the cover is pivotably coupled to the main body.

3. The reusable power module of claim 1, wherein the cover is slidably coupled to the main body.

4. The reusable power module of claim 1, wherein the cover includes at least one feature that cooperates with a corresponding feature of the main body to retain the cover in the second configuration.

5. The reusable power module of claim 4, wherein the at least one feature includes a snap.

6. The reusable power module of claim 1, wherein the cover includes a plurality of field communicator connection clips.

7. The reusable power module of claim 1, wherein the main body includes a plurality of conductors for providing power and communications to the field device.

8. The reusable power module of claim 1, wherein the chamber is configured to house a D-cell battery.

9. The reusable power module of claim 8, and further comprising a D-cell primary battery disposed in the main body.

10. The reusable power module of claim 9, wherein the D-cell primary battery is a lithium battery.

11. The reusable power module of claim 1, and further comprising a first circuit board mounted relative to the body.

12. The reusable power module of claim 11, and further comprising a pair of springs each spaced from a center of the first circuit board.

13. The reusable power module of claim 12, wherein the pair of springs provides passive polarity protection.

14. The reusable power module of claim 11, and further comprising a second circuit board mounted relative to the cover, and a plurality of conductors coupling the first and second circuit boards.

15. A field device comprising:
measurement circuitry operably coupled to at least one process variable sensor and configured to provide a digital indication relative to an electrical characteristic of the at least one process variable sensor;
a controller coupled to the measurement circuitry and configured to generate process variable information based on the digital indication;
process communication circuitry coupled to the controller, the process communication circuitry being configured to generate a process variable output based on the process variable information provided by the controller; and
a reusable power module operably coupled to the measurement circuitry, the controller, and the process communication circuitry, the reusable power module having:
a main body defining a chamber configured to house a battery;
a cover operably coupled to the main body, the cover having a first configuration relative to the main body wherein the main body is open and allows access to the battery, the cover also having a second configuration wherein access to the battery is closed, wherein when the cover is in the second configuration, the reusable power module complies with an intrinsic safety specification.

16. The field device of claim 13, and further comprising a lithium D-cell primary battery disposed in the main body.

17. The field device of claim 15, wherein the process communication circuitry is wireless process communication circuitry.

18. The field device of claim 15, wherein the cover is pivotally coupled to the main body.

19. The field device of claim 15, wherein the cover is slidable coupled to the main body.

20. A method of using a non-intrinsically safe primary power cell in a reusable power module to provide power to a field device located in a hazardous location, the method comprising:
providing a reusable power module;
obtaining a non-intrinsically-safe battery;
opening the reusable power module and inserting the non-intrinsically safe battery in the reusable power module;
closing the reusable power module;
moving to a hazardous location of the field device;
opening a cover of the field device;
removing a power module from the field device and inserting the reusable power module into the field device; and
closing the cover of the field device.

21. The method of claim 20, wherein closing the reusable power module includes pivoting a cover of the reusable power module relative to a main body of the reusable power module.

22. The method of claim 20, wherein closing the reusable power module includes sliding a cover of the reusable power module relative to a main body of the reusable power module.

23. The method of claim 20, wherein closing the reusable power module including snapping a cover of the reusable power module to a main body of the reusable power module.
